(19) United States
(12) Patent Application Publication
(10) Pub. No.: US 2012/0280026 A1
(43) Pub. Date: Nov. 8, 2012

(54) FLEXIBLE PACKAGING CONTAINER HAVING A BAG INSERT

(75) Inventors: Loic Faulon, Thollon Les Mernises (FR); Geof Radley, Yorkshire (GB)

(73) Assignee: NESTEC S.A., Vevey (CH)

(21) Appl. No.: 13/124,755

(22) PCT Filed: Oct. 7, 2009
(86) PCT No.: PCT/EP2009/063046

§ 371 Date: Nov. 2, 2011

(30) Foreign Application Priority Data
Oct. 17, 2008 (EP) 08166923.6

(51) Int. Cl. B65D 5/56; B31B 7/00

(52) U.S. Cl. 229/117.27; 493/83

(57) ABSTRACT

The invention relates to a dimensionally stable packaging container (1) formed by a folding box (2) and comprising: a first and a second side wall element (3a, 3b), said elements being connected to each other by several base sections (4, 5, 6) which are designed symmetrical to a base fold line (7), wherein each of the side wall elements (3a, 3b) comprises at least two connection tabs (8a, 8b) which are connected to the side wall elements (3a, 3b) in an articulated manner, wherein outer surfaces (10b) of the connection tabs (8a) of the first side wall element (3a) are connected to outer surfaces (11b) of the connection tabs (8b) of the second side wall element (3b) in such a way that the connection tabs of the two side wall elements point in the direction of the container interior (9), and wherein the packaging container further comprises a bag (13) which is composed of a film and which is connected to the side wall elements (3a, 3b) at least on the connection tabs (8a, 8b) of the folding box (2).

The present invention describes a self-supporting packaging container that comprises a folding box and a bag fitted therein.

Folding boxes which are intended for accommodating relatively small or relatively large volumes and can be folded together for transportation purposes are sufficiently known from the prior art. The folding boxes are produced usually from a rigid material, for example cardboard, and cutting or punching tools can be used to form an appropriately shaped folding-box blank therefrom. In order to connect the folding-box blank to give an open-out folding box, specific connecting elements which can be connected with the aid of adhesive bonding are usually provided. Such a folding box can easily be erected by a user in order to form, for example, a self-supporting container. The folding box here may also have inner bags in order to protect, for example, the contents against moisture or to provide a moisture-repellant surface within the erected folding box.

Document GB 1 536 110 describes a rigid container that can be used as a cup, and also describes a method for producing the same. A first blank formed from a rigid material and a second blank formed from a flexible material are arranged one upon the other, and the resulting layered structure is folded along the centre, and opposite connecting elements are connected, in order to provide, when the structure is erected, a stiff container which can be used as a cup.

In addition, WO 2007/090415 A1 discloses a packaging container with an inner bag which is produced in the form of a flat folding box, which can then be erected in order to form a stable self-supporting container.

Based on the prior art cited, it is an object of the present invention to provide an easy-to-produce folding-box blank which can be erected to give a folding box which is able to assume an at least partially flat state and a fully erected state.

It is also an object of the invention to provide a folding-box blank and a sheet-material blank located therein, which can easily be integrated in the folding-box blank, in order to provide a compact packaging container which is insulated in the outward direction. This is advantageous, in particular, if the container is to be used for accommodating or preparing liquid foodstuffs.

In a first aspect, the invention describes a dimensionally stable packaging container which is open in the upward direction and is formed by a folding box, having a first and a second side-wall element, which are connected to one another by a plurality of base portions, formed symmetrically in relation to a base folding line, wherein each of the side-wall elements has at least two connecting flaps, which are connected in an articulated manner to the side-wall elements, wherein outer surfaces of the connecting flaps of the first side-wall element are connected to outer surfaces of the connecting flaps of the second side-wall element such that the connecting flaps of the two side-wall elements are oriented in the direction of the container interior, and wherein the packaging container also has a bag, which consists of a sheet material and is connected to the side-wall elements at least at the connecting flaps of the folding box.

The folding-box blank according to the invention makes it possible to provide a laid-flat pack which can be transferred into an upright state by virtue of the side-wall elements being pressed together. The side-wall elements here are preferably subdivided in each case into a plurality of foldable portions, which are arranged symmetrically in relation to the base folding line of the folding-box blank. This ensures, in particular, a symmetrical construction of the folding box.

The connecting flaps are preferably arranged symmetrically in relation to the base folding line. Furthermore, the connecting flaps are preferably connected laterally in an articulated manner to the side-wall elements.

In addition, the connecting flaps preferably extend substantially over the entire side of the side-wall elements. However, it should be mentioned that it is also possible for more than two connecting flaps to be provided laterally on the side-wall elements. The connecting flaps are preferably substantially rectangular. However, it is also possible for the connecting flaps to be triangular or of some other geometrical shape.

The bag of the packaging container is preferably formed from a sheet-material blank. The bag preferably has a front bag wall and a rear bag wall, which are connected to one another in the longitudinal direction of the bag via laterally running sealing peripheries. The sealing peripheries of the bag are connected to the connecting flaps of the folding box. The laterally running sealing peripheries of the bag here are preferably sealed or adhesively bonded in the connection between the connecting flaps of the side-wall elements of the folding box. This allows a straightforward and space-saving connection between the bag and the folding box. In addition, the action of erecting the folded-together folding box also opens out the bag located therein.

The bag located in the folding box is welded in a fixed manner by the lateral sealing peripheries. The bag can thus serve to accommodate liquid.

The foldable portions of the side-wall elements of the packaging container produce vertical edges, when the container is erected, along which a user can hold the packaging container. This is advantageous, in particular, if the container is used for accommodating warm or hot liquids.

According to the invention, the packaging container may be either empty or filled. If the packaging container is empty, then the bag located therein is open in the upward direction. If the packaging container is filled, the bag located therein can be filled, for example, with dry, pasty or liquid substance. In this case, the bag is preferably closed in an air-tight manner.

The connecting flaps and the sealing peripheries are preferably connected to one another by the in each case at least two sealing or adhesive-bonding spots. However, it is also possible for the connecting flaps and the sealing peripheries of the bag to be connected by a sealing or adhesive-bonding seam extending in the longitudinal direction of the container.

It is also preferably the case that the first or second side-wall element has provided thereon adhesive-bonding locations, at which the bag located in the folding box is fastened on the side-wall elements of the folding box.

The adhesive-bonding locations on the side-wall elements are arranged on the first and second side-wall elements substantially perpendicularly to the longitudinal direction of the container. In addition to the connection between the sealing peripheries of the bag and the connecting flaps of the folding box, this ensures that the bag opens when the folding box is erected or opened out.

The folding box is preferably produced from cardboard or a transparent or opaque plastics material.

The bag is preferably formed from sheet material which has one or more layers. The sheet material may be a plastics sheet material and is laminated, if appropriate, with a paper layer. The sheet-material layers are preferably made up of aluminium, paper, polypropylene, polyethylene, polyester, polyamides or ethylene vinyl alcohol, which may be provided with additional coatings. The sheet material is closed up to give a sealed bag with the aid of adhesive-bonding or welding seams.

The thickness of the sheet material of the bag is preferably between 10 and 1000 μm. According to the invention, the bag and/or the folding box may or may not have printing on it/them.

In addition, the bag and/or the folding box may be provided with an insulation layer, for example, made of Styropor. This may be arranged between the bag and the folding box.

The inner bag may be closed in the upward direction with the aid of a welding or adhesive-bonding seam. For this purpose, the upper ends of the side walls of the bag may be adhesively bonded or sealed. It is possible to provide a special notch or a tear on the adhesive-bonding or sealing seam, this making it easy for the bag to be opened by a user. In addition, the welding or adhesive-bonding seam may be provided with perforations in order to facilitate opening of the bag by a user. Once the bag has been opened, the user can press the side walls of the packaging container towards one another in order to open the container and the bag located therein.

In a further preferred embodiment, the bag is closed in the upward direction by a material which is easy to pull off, for example polypropylene. This allows the bag to be opened easily by virtue of the side walls of the packaging container being pressed together.

The base portions of the folding box are preferably embodied so as to ensure that the packaging container is stable when the container is in an upright state.

For this purpose, it is advantageous, in particular, if a plurality of base portions are provided in the longitudinal direction of the base folding line. In addition, the outer base portions preferably have a contour which is in the form of part of a circle or of a gusset and is directed towards the inner base portions.

The greatest extent of the contour, in the form of part of a circle or of a gusset, here is preferably arranged in the direction of the side-wall portions. This can ensure, in particular, that, when the flat pack is erected, these base portions are erected to give a planar base part.

It is also possible for the outer base portions to have provided in them folding lines which run from the point of contact of the contour, in the form of part of a circle or of a gusset, on the base folding line and the outer edges of the outer side-wall portions. This can ensure that the base portions are opened out to even better effect. In addition, the base is provided with additional stiffening.

It is advantageously also possible to provide hook-like portions which are arranged in the region of the point of contact between the base folding line and the contours in the form of part of a circle or of a gusset. The hook-like portions can thus prevent the base of the folding box from collapsing in an undesired manner once in the erected state.

Furthermore, hook-like portions may be provided in the region of the base folding line on the outer boundary of the outer base portions. It is also the case that these outer hook-like portions can contribute to preventing the base from collapsing once the folding-box blank is in the erected state.

The longitudinal extent of the central base portion of the folding box, in addition, is preferably greater than the laterally arranged base portions.

It is advantageously possible to provide a constriction of the contour of the central base portion in the region of the base folding line. Such a configuration of the central base portion means that the outer base portions are directed, and moved into the envisaged planar position, when the folding box is opened out. This gives rise to a stable and closed base for the opened-out packaging container.

In a preferred embodiment, in addition, it is possible to provide barbs on the base portions in the region of the base folding lines and/or receiving means for barbs. The barbs and the corresponding receiving means allow the base portions to be connected to one another when the folding box has been erected. The box is thus prevented from collapsing.

In addition, it has proven very advantageous for a folding box produced from a blank according to one of the preceding embodiments if, when a blank pre-folded in the form of a W is erected, the base portions engage one inside the other and together form an at least more or less planar base, engaging firmly one inside the other in the process.

In a second aspect, the present invention describes a method for producing a dimensionally stable packaging container which is open in the upward direction, having the following steps:
punching out a folding box comprising two side-wall elements, which are connected to one another by a plurality of base portions formed symmetrically in relation to a base folding line, and which each have at least two connecting flaps,
applying adhesive-bonding locations to the side-wall elements of the folding box,
applying a sheet-material blank to the folding box, the blank being adhesively bonded to the side-wall elements of the folding box by means of the adhesive-bonding locations,
adhesively bonding or sealing the connecting flaps of the side-wall elements together with the sheet-material blank such that the connecting flaps are oriented in the direction of the container interior and thereby adhesively bonded or sealed laterally running peripheries of the sheet-material blank are arranged between the connecting flaps.

It is preferably the case that the sheet-material blank, for applying to the folding box, is already adhesively bonded or sealed at the side walls. Accordingly, the sheet-material blank forms a bag of which the lateral adhesively bonded or sealed peripheries are adhesively bonded or sealed in the connection between the connecting flaps of the side-wall elements of the folding-box blank.

The connecting flaps of the side-wall elements are preferably connected to one another by way of their outer surfaces. For this purpose, the connecting flaps of the two side-wall elements are folded over in the direction of the container interior prior to being connected. The adhesive-bonding spots or the adhesive-bonding seam can be applied before or after the connecting flaps have been folded over.

Advantageous embodiments of the packaging container according to the invention will be explained with reference to the following figures, in which:

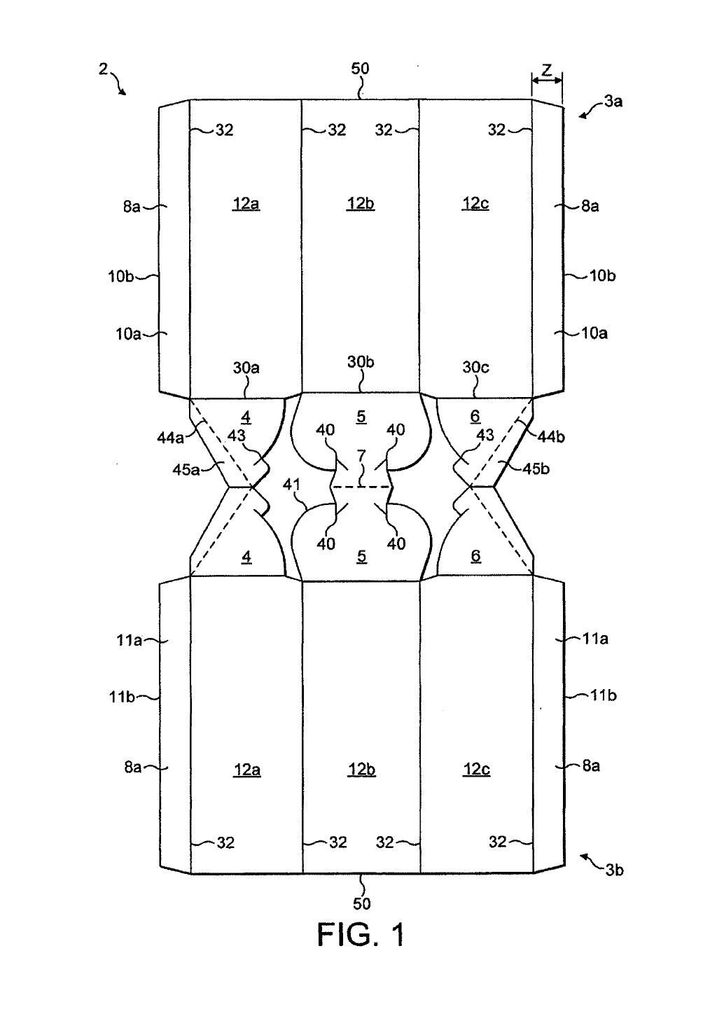

FIG. 1 shows a preferred embodiment of a folding-box blank according to the invention with a plurality of base portions and connecting flaps arranged laterally on the side-wall elements,

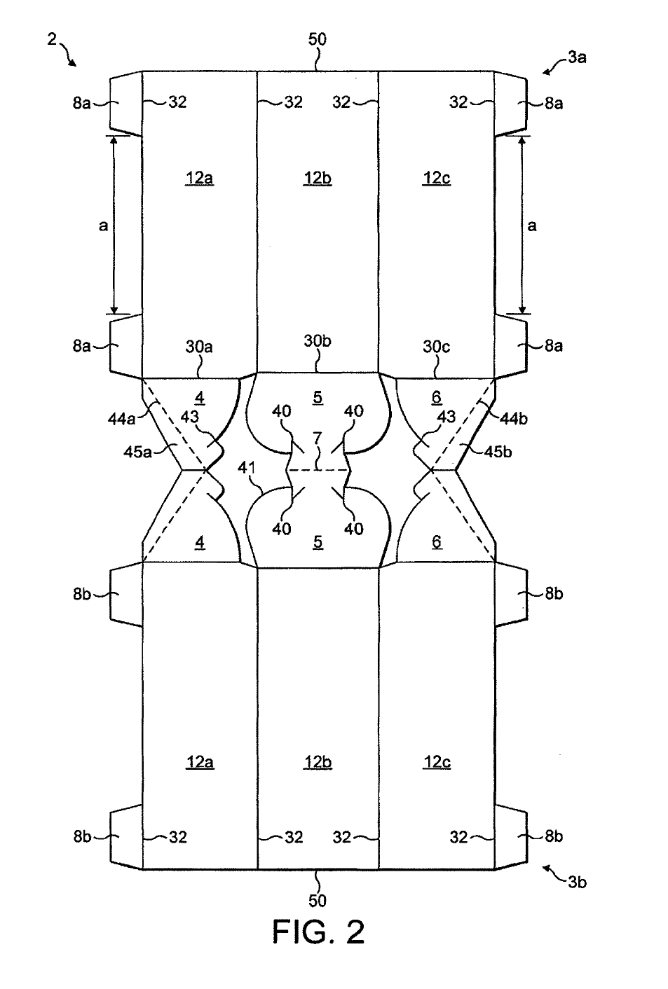

FIG. 2 shows a further preferred embodiment of the folding-box blank according to the invention, with an alternative embodiment of the connecting flaps arranged laterally on the side-wall elements.

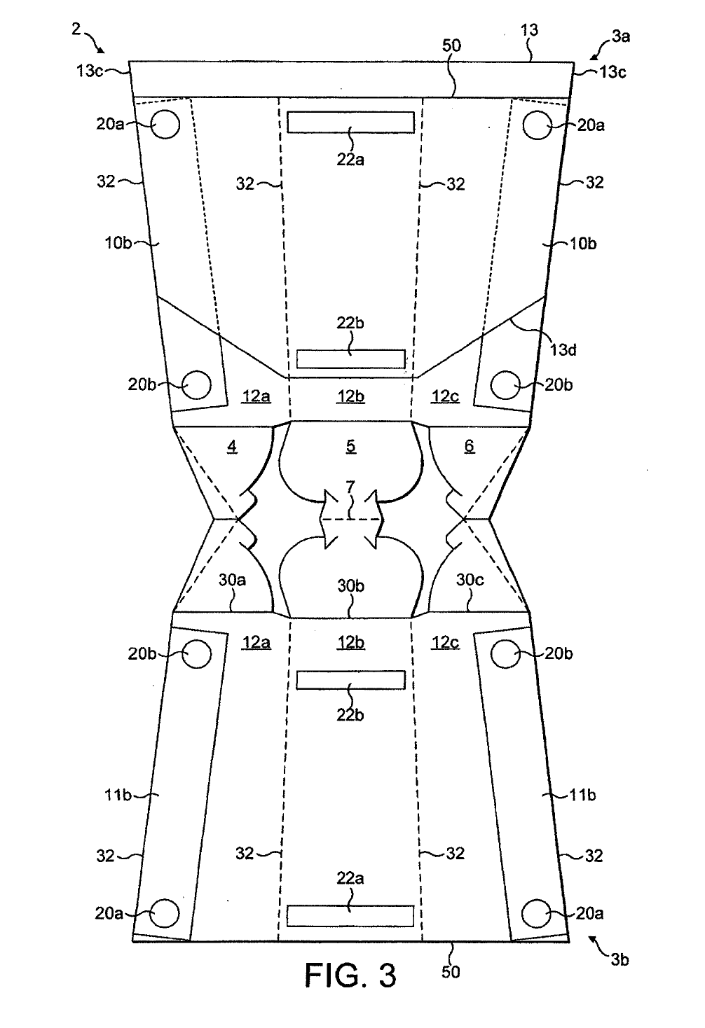

FIG. 3 shows a further preferred embodiment of the folding-box blank, wherein the specific geometry of the blank gives rise to the opened-out packaging container being in the form of a cup which widens upwards,

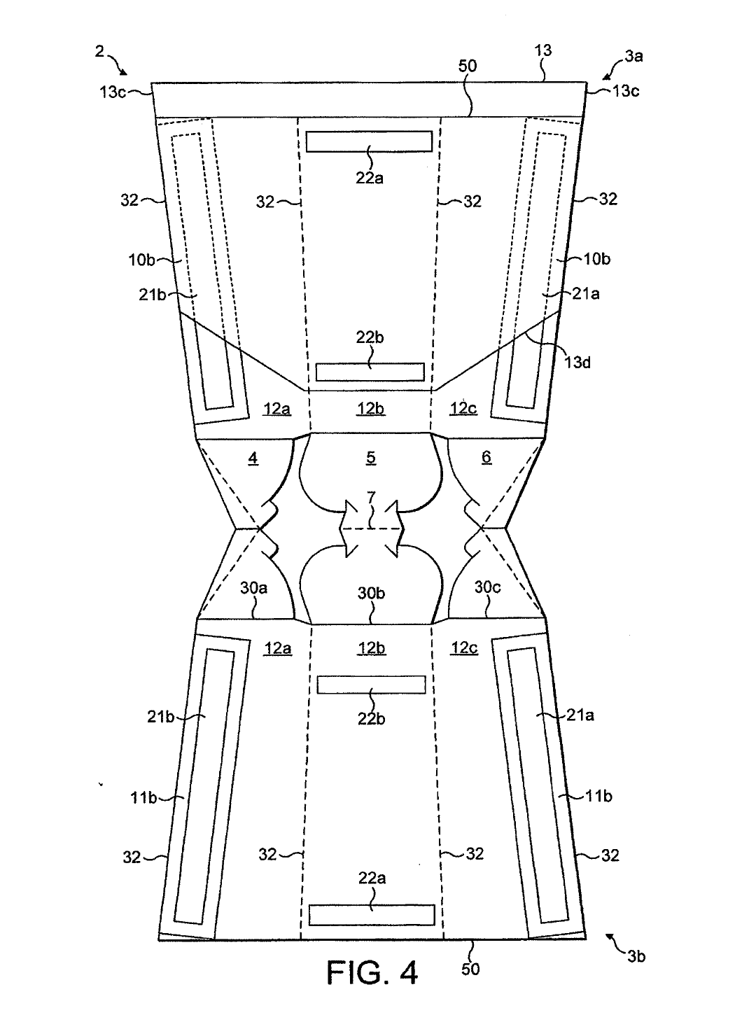

FIG. 4 shows a further preferred embodiment of the folding-box blank, wherein adhesive-bonding seams, rather than adhesive-bonding spots, are provided on the connecting flaps,

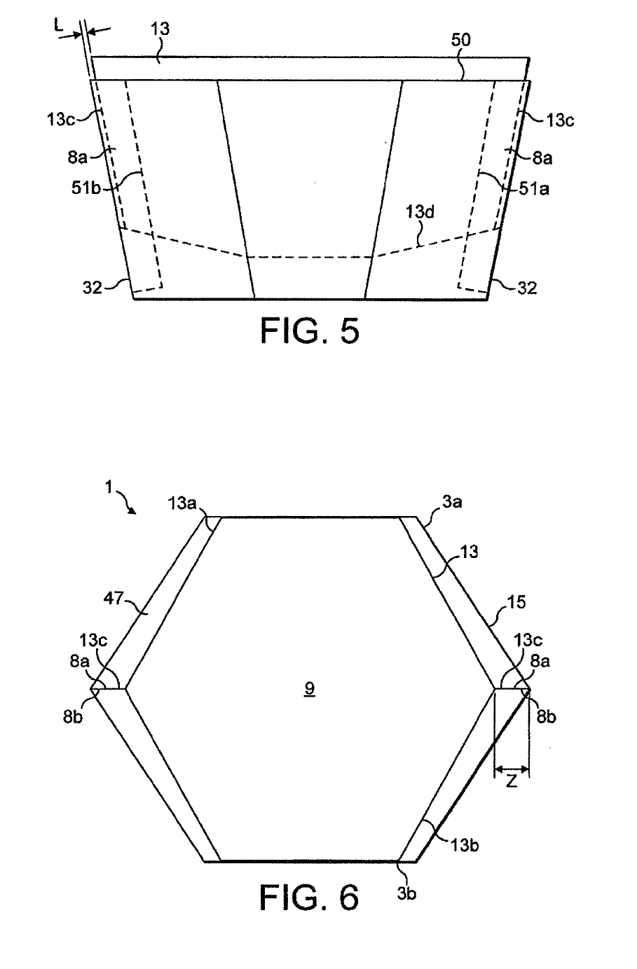

FIG. 5 shows a side view of the folded packaging container with the bag located therein,

FIG. 6 shows a plan view of a preferred embodiment of an opened-out packaging container.

FIG. 1 shows a folding-box blank 2 according to the invention with two side-wall elements 3a, 3b, which comprise substantially a plurality of foldable portions 12a, 12b, 12c. The side-wall elements 3a and 3b here have folding lines 32 which extend preferably in the longitudinal direction of the container and separate the individual foldable portions 12a, 12b, 12c from one another.

In each case three foldable portions 12a, 12b, 12c are preferably provided per side-wall element 3a, 3b. The opened-out packaging container 1 (cf. FIG. 6) thus assumes the form of a hexagonal container. The number of foldable portions, however, may differ from the number of portions shown. For example, two foldable portions may be provided per side-wall element 3a, 3b. The resulting packaging container would thus be quadrilateral in shape.

The folding lines 32 are arranged substantially perpendicularly to the base folding line 7. As shown in FIG. 1, the folding lines 32 can extend parallel to one another. However, it is also possible for the spacing between the folding lines 32 to increase, starting from the base folding line 7, to the outer edges 50 of the folding-box blank. This can result, in particular, in the opened-out packaging container being in the form of a cup which opens in the upward direction (cf. FIG. 3).

The side-wall elements 3a, 3b are arranged preferably symmetrically in relation to the base folding line 7.

The side-wall elements 3a, 3b each have a plurality of base portions 4, 5, 6, which are arranged in each case symmetrically in relation to the base folding line 7. The base portions 4, 5, 6 are connected in an articulated manner to the foldable portions 12a, 12b, 12c of the side-wall elements 3a and 3b by means of folding lines 30a, 30b, 30c, which are arranged preferably parallel to the base folding line 7.

In the vicinity of the folding line 7, hook-like incisions 40 are provided in the central base portions 5. Starting from the base folding line 7, the width of the central base portions 5 increases, and a protrusion 41 is therefore formed. Starting from this protrusion 41, the central base portions 5 become narrower again, so that they assume the width of the adjacent portions 12b.

Connecting flaps 8a, 8b are arranged on those sides of the side-wall portions 12a and 12c which are directed away from the portions 12b, these connecting flaps being connected to the respective foldable portions 12a, 12b by a folding line 32.

The connecting flaps 8a, 8b extend preferably over the entire side length of the side-wall elements 3a, 3b. The connecting flaps 8a, 8b here have an inner surface 10a, 11a and an outer surface 10b, 11b. The outer surfaces 10b, 11b constitute those surfaces of the connecting flaps 8a, 8b which are located on the outside when the folding-box blank is in the folded-together state, that is to say in a state in which the folding-box blank has been folded about the base folding line 7. Accordingly, the inner surface 10a, 11a of the connecting flaps 8a, 8b is understood as being those surfaces of the connecting flaps which are located one upon the other when the folding-box blank is in the folded-together state.

The base portions 4 and 6 are provided, in the region of the base folding line 7, with hook-like incisions 43 which, when the blank is opened out to give a pack, engage in the hook-like incisions 40 of the central base portions 5 and latch therein.

Reinforcing portions 45a and 45b are fitted in an articulated manner on the base portions 4 and 6 via the folding lines 44a, 44b. When a pack formed from the folding-box blank 2 is opened out, the base formed in the container is provided with additional stiffening by reinforcing portions 45a, 45b.

If the folding-box blank is folded flat following connection with the aid of the connecting flaps, the respective base portions 4, 5, 6 of the side-wall elements are folded inwards between the side-wall elements, and this gives a W-shaped configuration as seen from the side.

A correspondingly formed folding box can be transported in a straightforward and space-saving manner.

In order to erect the flat pack, the folding edges 32 of the side-wall elements 3a, 3b are pressed towards one another. The base portions 4, 5, 6 are thus opened out into a base-forming plane. The base portions 4 and 6 here are directed by the protrusions 41, and therefore the barbs formed from the cut lines 40, 43 engage in one another. The shapings of the individual base portions 4, 5, 6 are coordinated with one another such that the barbs engage precisely when the base, formed from the base portions, is being opened out.

The action of the barbs hooking in here gives rise to an extremely stable and firm base for the folding box.

FIG. 2 shows a further preferred embodiment of the folding-box blank 2 according to the invention. The connecting flaps 8a, 8b of the side-wall elements 3a, 3b here are embodied such that they do not extend over the entire side length of the side-wall elements 3a, 3b. As is shown in FIG. 2, in each case two connecting flaps 8a, 8b are fitted in an articulated manner on each of the portions 12a and 12c of the side-wall elements 3a, 3b. The connecting flaps 8a, 8b here are fitted laterally on the side-wall elements 3a, 3b preferably at a maximum spacing a from one another. One of the two connecting flaps 8a, 8b here is arranged preferably flush with the outer edge 50 of the side-wall elements 3a, 3b. The other connecting flap 8a, 8b arranged on the corresponding side is arranged preferably flush with the inner folding edge 30a, 30c. This ensures a fixed connection of the outer edges 50 and of the inner edges 30a, 30c when the folding box 2 is in the opened-out state.

The connecting flaps are preferably rectangular. However, it is also possible for the connecting flaps to have rounded edges or to be of undulating form. In addition, the connecting flaps may have a plurality of convexities or incisions.

As an alternative, it is also possible for more than the two connecting flaps 8a, 8b shown to be arranged on the outer foldable portions 12a, 12c of the side-wall elements 3a, 3b.

FIG. 3 shows a further preferred embodiment of the folding-box blank 2, wherein the specific geometry of the blank gives rise to the opened-out packaging container being in the form of a cup which widens upwards. This is achieved, in particular, in that the folding edges 32 become spaced apart from one another as they extend from the base folding line 7 in the direction of the outer edge 50. The opened-out packaging container 1 thus has an opening which widens in the upward direction, and this makes it easier to introduce liquid.

As shown in FIG. 3, the connecting flaps of the side-wall elements 3a, 3b are folded over inwards along the folding edges 32, and therefore the outer surfaces 10b of the first side-wall element 3a and the outer surfaces 11b of the second side-wall element 3b are located on the same side of the folding-box blank.

Once the connecting flaps 8a, 8b have been folded over, adhesive-bonding spots 20a, 20b are applied to the outer surfaces 10b, 11b of the connecting flaps 8a, 8b. For each connecting flap 8a, 8b, at least one adhesive-bonding spot 20a is preferably located at the upper end of the connecting flap, in the vicinity of the outer edge 50 of the side-wall elements 3a, 3b. In addition, for each connecting flap 8a, 8b, at least one adhesive-bonding spot 20b is located at the lower end of the connecting flap, in the vicinity of the inner edges 30a, 30c of the side-wall elements 3a, 3b.

In a preferred embodiment, in addition, adhesive-bonding spots or adhesive-bonding seams 22a, 22b are applied to at least one of the foldable portions 12a, 12b, 12c oriented in the direction of the container interior 9 (cf. FIG. 6). The adhesive-bonding seams or spots 22a, 22b are applied preferably to the central portion 12b of the respective side-wall elements 3a, 3b. This means that a bag 13 which is intended for fitting within the folding box can be fixed, in addition, on the side-wall elements 3a, 3b of the packaging container, and this allows the bag 13 to be opened easily when the folding-box blank 2 is opened out.

As shown in FIG. 3, an adhesive-bonding seam 22a extends, preferably parallel to the base folding edge 7, in the vicinity of the outer edge 50. The other adhesive-bonding seam 22b extends, preferably parallel to the first adhesive-bonding seam 22a, in the vicinity of the inner folding edges 30a, 30b, 30c. The two adhesive-bonding seams 22a, 22b may be located on one of the foldable portions 12a, 12b, 12c. However, it is also possible for a continuous adhesive-bonding seam, extending over at least two of the foldable portions 12a, 12b, 12c, to be applied to the respective side-wall elements 3a, 3b. Instead of a continuous adhesive-bonding seam 22a, 22b, it is also possible for a series of adhesive-bonding spots lined up in a row one beside the other to be applied to the side-wall elements 3a, 3b.

Once the adhesive-bonding spots or adhesive-bonding seams have been applied, an appropriately pre-formed sheet-material bag 13 is positioned on one of the two side-wall elements 3a or 3b. The bag here is preferably formed such that its side edges 13c terminate flush with the outer edges 32 of the folding-box blank 2. However, it is also possible for the side edges 13c of the bag 13 to be offset some way inwards. In any case, overlapping of the outer bag edges 13c and of the outer surfaces 10b, 11b of the connecting flaps is created.

The bag 13 is sealed or adhesively bonded preferably at its side edges 13c. In addition, the base 13d of the bag is sealed or adhesively bonded. The bag 13 can contain, for example, moisture-sensitive material which increases in volume upon interaction with liquid. The sheet-material bag here can serve as a moisture barrier and/or as a grease barrier, and therefore grease or moisture contained in the bag cannot pass into the material of the folding box.

As shown in FIG. 3, the adhesive-bonding seams or adhesive-bonding spots 22b are arranged preferably in the vicinity of, or up against, the base edge 13d of the bag 13. The adhesive-bonding seams or adhesive-bonding spots 22a are arranged preferably in the vicinity of, or up against, the outer edge 50 of the respective side-wall elements 3a, 3b.

Once the adhesive-bonding seams or adhesive-bonding spots have been applied, the folding-box blank 2 can be folded in relation to the base folding line 7, and therefore the surfaces 10b, 11b of the connecting flaps 8a, 8b of the two side-wall elements 3a, 3b are folded one upon the other. The adhesive-bonding spots 20a and 20b of the respective side-wall elements 3a, 3b are thus folded one upon the other. When the folding-box blank is folded together, accordingly, the bag 13 is also pressed in between the connecting flaps 8a, 8b of the side-wall elements. The welded side peripheries 13c of the bag 13 here are connected to the connecting flaps 8a, 8b of the two side-wall elements 3a, 3b. The sheet-material bag 13 is thus also adhesively bonded in the seams made from the connecting flaps 8a, 8b.

The shape of the adhesive-bonding spots or adhesive-bonding seams 20a, 20b, 22a, 22b may differ from the shape shown in FIG. 3. In addition, it is possible for a plurality of adhesive-bonding spots 20a, 20b to be applied to the connecting flaps 8a, 8b.

Instead of the described use of adhesive-bonding spots or adhesive-bonding seams, it is also possible for the folding-box blank 2 to be sealed or welded to the bag 13.

As shown in FIG. 3, the bag 13 can project out some way beyond the upper outer edge 50 of the folding-box blank 2.

It is also possible for the adhesive-bonding spots or adhesive-bonding seams 20a, 20b to be applied just to one of the two side-wall elements 3a, 3b, in order to ensure a secure connection of the side-wall elements 3a, 3b when the folding box is in the folded-together state.

FIG. 4 shows a further preferred exemplary embodiment of the folding-box blank 2 according to the invention, in which an adhesive-bonding seam 21a, 21b, instead of the adhesive-bonding spots 20a, 20b, is applied to the connecting flaps 8a, 8b. It should be mentioned that the connecting flaps 8a, 8b may also be connected with the aid of a welding seam instead of the adhesive-bonding seam.

It should also be mentioned that the sheet-material blank 13 may be connected directly to the connecting flaps 8a, 8b at the sides 13c with the aid of a welding seam 21b, 21a.

FIG. 5 shows a side view of the folded-together pack 1. As illustrated by the folded-in outer edges 51a, 51b, which are shown by dashed lines, the side edges 13c of the bag and the folded-in outer edges 51a, 51b overlap. The side edges 13c of the bag can butt against the outer edges 32 of the packaging container 1. However, the outer edges 13c are preferably offset inwards by the length L.

FIG. 6 shows a plan view of a packaging container 1 according to the invention. As shown, the connecting flaps 8a, 8b of the two side-wall elements are arranged, and connected, such that they are oriented in the direction of the container interior 9. This avoids troublesome fin seams on the outer surface of the container. In addition, the connecting flaps project in the direction of the container interior, and therefore the side walls 13a, 13b of the sheet-material bag 13 do not butt directly against the side-wall elements 3a, 3b. This gives rise to an air space 47 being created between the side-wall elements and the bag 13, and the air space has an insulating function. The dimension of the air space 47 can be varied here by virtue of the length Z of the connecting flaps 8a, 8b being varied. Such an insulation is advantageous particularly if the container is used for the preparation of soups or other hot foodstuffs.

It should be pointed out that the invention is not restricted to the exemplary embodiments described above. In particular it is possible to provide further foldable portions and/or base portions and thus to create a packaging container which has more corners than in the examples illustrated. It is also conceivable for the side-wall elements each to have only two foldable portions and thus to be opened out into a more or less rectangular pack.

1. Dimensionally stable packaging container formed by a folding box, comprising:
a first and a second side-wall element, which are connected to one another by a plurality of base portions, formed symmetrically in relation to a base folding line;
wherein each of the side-wall elements has at least two connecting flaps, which are connected in an articulated manner to the side-wall elements;
outer surfaces of the connecting flaps of the first side-wall element are connected to outer surfaces of the connecting flaps of the second side-wall element such that the connecting flaps of the two side-wall elements are oriented in a direction of the container interior; and
the packaging container includes a bag, comprising a sheet material and is connected to the side-wall elements at least at the connecting flaps of the folding box.

2. Packaging container according to claim 1, wherein the side-wall elements each have a plurality of foldable portions, which are arranged symmetrically in relation to the base folding line.

3. Packaging container according to claim 1, wherein the connecting flaps of the side-wall elements are arranged symmetrically in relation to the base folding line.

4. Packaging container according to claim 1, wherein the bag is formed from a sheet-material blank and has a front bag wall and a rear bag wall, which are connected to one another in a longitudinal direction of the bag via laterally running sealing peripheries, and the lateral sealing peripheries of the bag are connected to the connecting flaps of the folding box.

5. Packaging container according to claim 4, wherein the laterally running sealing peripheries of the bag are sealed or adhesively bonded between the connecting flaps of the side-wall elements.

6. Packaging container according to claim 5, wherein the connecting flaps and the sealing peripheries of the bag are each connected to one another by at least two sealing or adhesive-bonding spots.

7. Packaging container according to claim 5, wherein the connecting flaps and the sealing peripheries of the bag are connected by a sealing or adhesive-bonding seam extending in a longitudinal direction of the container.

8. Packaging container according to claim 4, wherein the bag is also fastened on the first and second side-wall elements of the folding box by means of adhesive-bonding locations.

9. Packaging container according to claim 8, wherein in each case at least two adhesive-bonding locations are arranged on the first and second side-wall elements that are substantially perpendicular to the longitudinal direction of the container.

10. Packaging container according to claim 1, wherein the folding box comprises a material selected from the group consisting of cardboard, a transparent platter and an opaque plastic material.

11. Packaging container according to claim 4, wherein the bag is formed from a plastic sheet having at least one layer.

12. Packaging container according to claim 11, wherein the thickness of the sheet material of the bag is between 10 and 1000 micrometers.

13. Packaging container according to claim 1, wherein the base portions of the folding box are embodied so as to ensure that the packaging container is stable when the container is in an upright state.

14. Packaging container according to claim 1, wherein an outer surface of the packaging container has printing on it.

15. Method for producing a dimensionally stable packaging container which is open in an upward direction, comprising:
punching out a folding box comprising two side-wall elements, which are connected to one another by a plurality of base portions formed symmetrically in relation to a base folding line, and which each have at least two connecting flaps;
applying adhesive-bonding locations to the side-wall elements of the folding box;
applying a sheet-material blank to the folding box, the blank being adhesively bonded to the side-wall elements of the folding box using the adhesive-bonding locations; and
adhesively bonding or sealing the connecting flaps of the side-wall elements together with the sheet-material blank such that the connecting flaps are oriented in a direction of the container interior and thereby adhesively bonded or sealed laterally running peripheries of the sheet-material blank are arranged between the connecting flaps.

16. Packaging container according to claim 11, wherein the plastic sheet material is laminated with a paper layer.
